(19) United States
(12) Patent Application Publication
(10) Pub. No.: US 2013/0098818 A1
(43) Pub. Date: Apr. 25, 2013

(54) MODULAR WATER TREATMENT SYSTEM

(71) Applicant: Jason I.N. Beath, Queensland (AU)

(72) Inventor: Jason I.N. Beath, Queensland (AU)

(21) Appl. No.: 13/806,721

(22) PCT Filed: Jun. 28, 2011
(86) PCT No.: PCT/AU11/00785

§ 371 Date: Dec. 21, 2012

(30) Foreign Application Priority Data
Jun. 30, 2010 (AU) 2010902882

(51) Int. Cl. C02F 1/52

(52) U.S. Cl. CPC C02F 1/5281
USPC 210/170.05; 210/170.01

(57) ABSTRACT

Apparatus for the treatment of a substance such as a liquid includes a treatment pit (10) which has a plurality of chambers (1 to 8). Walls (24, 26, 28, 30, 32, 34) separate the chambers. Apertures (36) are located in non-adjacent walls (24, 28, 32) near the base of the pit (10). Further apertures (38) are located in non-adjacent walls (30, 34, 40), near the top of the pit (10). The liquid is introduced into the first chamber (1), and reagents added to the liquid. The water and reagent mix then flows through apertures (36) in the wall (24) between the first (1) and second (2) chambers into the second (2) chamber. Further reagents may be added in the second (2) chamber. The water and reagent mix then flows through apertures (38) in the wall (26) between the second (2) and third (3) chambers into the third (3) chamber. This process continues until the water reaches the final (8) chamber, from which it is discharged.

### TECHNICAL FIELD

This invention relates to the treatment of substances such as liquids, and in particular relates to the treatment of contaminated water which may form a body of water such as a lake or dam, be flowing in a watercourse such as a river bed, or be the output from an industrial process. More particularly, the invention relates to a modular water treatment system for operation in such locations, or for dealing with the results of such processes.

### BACKGROUND ART

A general overview of the treatment of contaminated water is contained in WO 2004/067455. Prior treatment systems and apparatus, more specifically directed towards the area of the present invention, feature a vessel which is adapted to float in a body of water to be remediated. WO 2007/121509 discloses a buoyant body which floats on a body of water, the body supporting a tank in which water pumped from the body of water is exposed to bacteria to treat the water. WO 2009/029381 describes a water remediation and biosolids collection system, in which a treatment vessel comprised of a water-impervious lining is located in a depression adjacent to or in a body of water. Water to be treated is transported from the body of water to a treatment portion of the vessel. These prior arrangements are relatively simple in construction and operation, and do not permit a range of treatment methods to be carried out with modular process changes.

Many contaminated sites, in respect of which water treatment is required, do not have enough room for treatment systems, or cannot justify the cost of the infrastructure required for the contaminated water to be treated.

It is an object of this invention to provide an improved apparatus or system for the treatment of contaminated substances, in particular water.

### SUMMARY OF INVENTION

The invention provides apparatus for use in the treatment of a substance, in particular a liquid, and more particularly contaminated water, said apparatus including a structure for location in a depression or the like, preferably adjacent a body which consists of or contains said substance, or being adapted to be located in a watercourse or the like, or being adapted to float on and/or in said body, said structure being characterised by at least one chamber in which said substance is treated before being returned to said body or being transferred to another location.

Preferably, said structure contains a plurality of said chambers.

Preferably, said chambers are separated by walls, said walls being provided with one or more apertures, through which or each said aperture said substance may pass from one chamber to an adjacent chamber.

Preferably, said apertures are located in different parts of successive walls.

Preferably, said apertures are located towards the top of a first wall, and towards the base of the next wall, or vice versa.

Preferably, when said apparatus is intended to float in a body of liquid, said structure is provided with float means.

Preferably, means are associated with said float means to adjust the height of said apparatus relative to the surface of said body of liquid.

Preferably, said apparatus is adapted to be constructed in a modular form, such that one modular part may contain one or more of said chambers, said one modular part being adapted to be connected to a second modular part which may contain one or more of said chambers.

### BRIEF DESCRIPTION OF DRAWINGS

FIG. 1 is a side elevation of a treatment pit in accordance with one embodiment of the present invention;

FIG. 2 is a top plan view of the pit of FIG. 1;

FIG. 3 is a side elevation of a floc extraction system for use with the pit of FIG. 1;

FIG. 4 is an end elevation of a first boundary wall between one chamber of the pit of FIG. 1 and the adjacent chamber;

FIG. 5 is an end elevation of a second boundary wall between one chamber of the pit of FIG. 1 and the adjacent chamber; and

FIG. 6 is an end elevation of the pit of FIG. 1, showing more detail of the floc extraction system of FIG. 3.

### BEST MODE FOR CARRYING OUT THE INVENTION

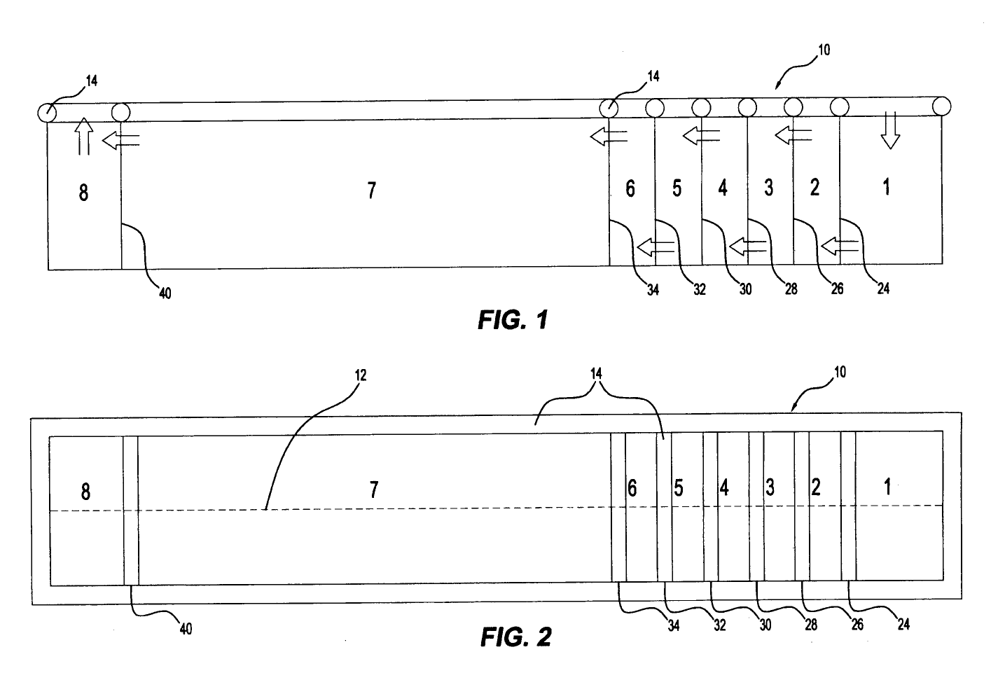

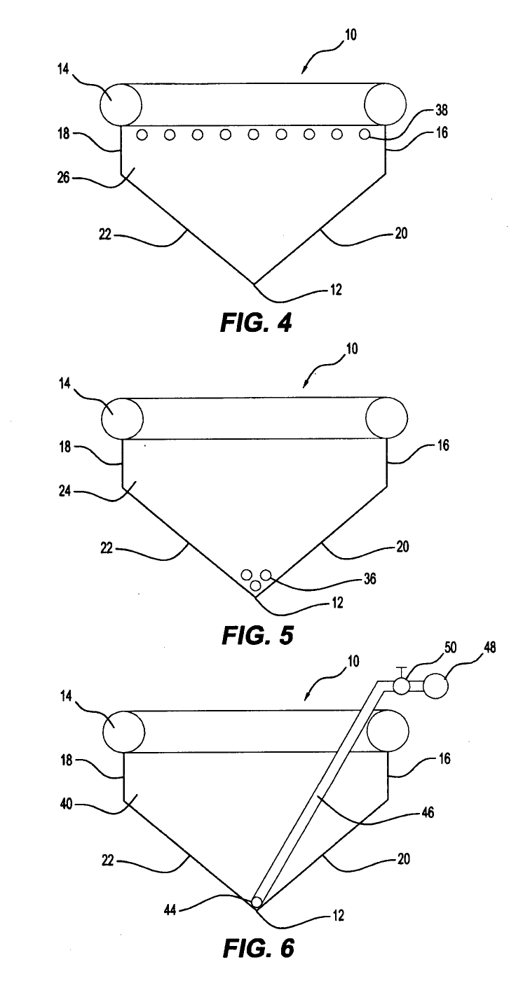

Referring firstly to FIGS. 1 and 2, the treatment pit 10 is preferably manufactured from polypropylene, more preferably reinforced 1.1 mm polypropylene, although any other suitable material may be used. In this embodiment, the pit is an elongated rectangle in plan, and has a V-shaped base 12 (FIGS. 4, 5 and 6). Obviously, the pit could be any shape, and have a base of any suitable configuration.

The pit 10 may be positioned in a depression or the like adjacent to a body of water, or arranged to float on the body of water. In the first alternative, the pit 10 may not require any supporting means for the material of the pit 10, as the material of the depression may take the place of such supporting means which may be required in the second, floating, alternative arrangement. One such depression may be a watercourse of a river or stream, where the pit 10 may treat water in that river or stream. In the second alternative, as shown in FIGS. 1 and 2, floats 14 may be constructed from a tube bladder which may be inserted into an envelope (not shown) manufactured into the top of the pit 10 sides and chamber (to be described hereinafter) tops. These floats 14 provide flotation and rigidity to the structure of pit 10. It also provides a double layer of material for puncture protection for the pit 10 and further rigidity. It makes bladder replacement easier with such an arrangement. Other solid or flexible float means may be employed. The float chamber may be built into the structure of pit 10 without the requirement for an internal bladder. The float mechanism may alternatively be formed from rigid pipe or an equivalent structure.

The sides 16, 18 (FIGS. 4, 5 and 6) of the pit 10 may be held together (to stop expansion and bellowing) with rope (not shown) attached to the insides of the pit along its length at spacing of preferably approximately ½ to ¾ its width. Alternatively, the sides 16, 18 could be held together by mesh, somewhat like the orange safety mesh used as a barrier at road works. The advantage of using mesh would be that apart from holding the sides 16, 18 together, it may act to further mix water as it passes along the length of pit 10, in a manner to be described hereinafter. There are different types of mesh envisaged for this embodiment. Some types have large apertures, and some have small apertures. Different types of mesh may be matched to the treatment and mixing required relative to aperture size and flow rates. This may also assist in providing laminar flow, and therefore better settling of floc.

The pit 10 may have one or more treatment chambers. In the present embodiment, the pit 10 has eight chambers, numbered from 1 to 8. As best shown in FIGS. 4, 5 and 6, the cross-sectional profile of the pit 10 includes vertical (in use) sides 16, 18 at the top of pit 10, with inwardly sloping sides 20, 22 below side walls 16, 18. An alternative for pit 10 may involve the use of inwardly sloping sides, such as sides 20, 22, only.

Chamber 1, as shown by way of preference, is larger than chambers 2 to 6 inclusive, each of which is preferably approximately the same size. Chamber 7 is the largest chamber, preferably, and chamber 8 is, by way of preference, about the same size as chamber 1. Chamber 7, which as will be described hereinafter as a flocculation chamber, need not be as large as shown. Alternatively, it may need, for a specific task, to be larger than shown. The size of each of the chambers 1 to 8 may be adjusted to suit requirements.

There are walls 24, 26, 28, 30, 32 and 34 separating chambers 1 and 2, 2 and 3, 3 and 4, 4 and 5, 5 and 6 and 6 and 7, respectively. Turning now to FIG. 5, wall 24 is shown. In this preferred embodiment, walls 28 and 32 would be at least substantially the same as wall 24. Apertures 36 are located in wall 24. The apertures 36 may take any number, form or shape, and may be arranged in any pattern. As shown by way of preferment, apertures 36 are located near the V-shaped base of pit 10.

FIG. 4 shows wall 26. In this preferred embodiment, walls 30, 34 and 40 would be at least substantially the same as wall 26. Apertures 38 are located in wall 26. The apertures 38 may take any number, form or shape, and may be arranged in any pattern. As shown by way of preferment, apertures 38 are located near the top of pit 10.

It can be seen from the horizontal arrows in FIG. 1 that walls of the type of wall 24 and wall 26 are staggered along the length of pit 10. A “high aperture” wall such as 26 has “low aperture” walls 24 and 28 before and after it, in the direction of the arrows in FIG. 1, and this pattern is repeated for walls 30, 32 and 34. Wall 40, (not shown in detail) is at least substantially the same as wall 26, 30 34, and separates chambers 7 and 8.

The pit 10 operates as follows. Contaminated water is supplied from the body of water or from an external source to chamber 1, preferably by being pumped into that chamber. This allows stabilization of turbulent inflow water in chamber 1, and initial mixing of reagents with the water if the reagents are injected into the water in chamber 1 at this stage.

The water and reagent mix then travels down chamber 1, from right to left in FIG. 1, and passes through apertures 36 at the base 12 of wall 24 into chamber 2.

The water then flows upwards within the next chamber, chamber 2, to then pass through apertures 38 at the top of wall 26 into chamber 3, just below floats 14. Different reagents may be injected into each of chambers 1, 2, 3, 4, 5 or 6. As required by the particular treatment process, or for any other reason.

The water continues to flow through chambers 1, 2, 3, 4, 5 and 6, alternately flowing through lower apertures 36, then upwards to flow through apertures 38, then downwards, and so on, providing a mixing facility for water and reagent before it enters chamber 7. The spacing of these first few mixing chambers of chambers 1 to 8 and the size of apertures 36, 38 decides the aggressiveness of mixing. Other types of static or moving mixers may be placed in the apertures 36, 38 or in other places where liquid flow occurs, or to induce the flow of liquid. Single or several mixers in apertures 36, 38 may be utilised.

Once in chamber 7 the water and floc is allowed to stabilize and create laminar flow, which allows the floc to settle out at the bottom 12 of the pit 10. As the water travels through chamber 7 the floc separates and settles to the bottom 12 so that the clean treated water can exit chamber 7 at the top through apertures in wall 40 (not shown, but being but similar to apertures 38 in FIG. 4, but preferably not being located as high in wall 40 as apertures 38 in walls 26, 30 and 34) just below the floats 12. The clean treated water enters chamber 8 from which it may be discharged to the body of water, for example by being pumped out, or the clean treated water may be pumped to an external location, such as a dam, tank or reservoir.

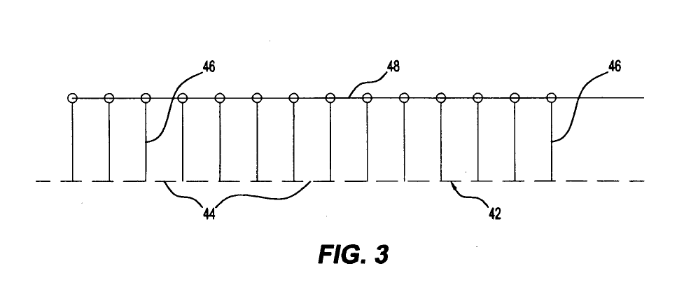

FIGS. 3 and 6 show the arrangement in pit 10 for the extraction of floc. The floc is extracted from the pit 10 system via a longitudinal pipe 42 placed at the bottom of the “V” (12) in the pit 10. This floc extraction pipe 42 is divided into sections of about ⅓ to ½ of the width of the pit 10. The pipe 42 has holes 44 drilled along its length at calibrated lengths to extract the floc. Each of these sections of pipe 44 has a vertical extraction pipe 46 which lays along the side of the pit 10 to near the float 12 on one side: see FIG. 6.

Alternatively, the combination of the vertical floc extraction pipes 42 and valves could be omitted. The floc could be extracted lengthways through the floc extraction pipe 42 using no valves, and requiring calibrated apertures in the lower floc pipe to regulate the floc extraction rate in different areas of pit 10.

By way of an example, for a pit that is about 45 metres long by about 7 metres wide, this pit embodiment may have eight to fifteen longitudinal floc extraction pipe sections with eight to fifteen corresponding vertical extraction pipes 46 feeding into one header pipe 48. Each of these pipes 46 has a valve 50 at the top just before the pipes 46 enter the header pipe 48, which is connected to a pump (not shown). By way of preference, pipe sections 46 may be located only in chamber 7, although they may also be located in one or more of chambers 1 to 6.

Header pipe 48 collects the floc from each of the base pipes 46 at a pre adjusted rate, utilizing valves. The floc may then be disposed of or recycled through the process to provide better reagent usage, contaminant extraction and floc density.

The volume of water in the chambers 1 to 8, and therefore the level at which the floats 12 sit in the water is preferably adjustable by a level sensor (not shown) attached to the side of the pit 10. This level sensor either changes the input or output pump speeds or opens and closes a valve to release more or less water from the final chamber, chamber 8. As the pit 10 sinks, the sensor slows the input pumps (or increases the speeds of the output pumps) or opens an exit valve. This keeps a constant volume in the pit 10 and therefore keeps the pit 10 at a constant level in the water. Another sensor could be associated with the previously described means to hold the sides 16, 18 of the pit 10 together. Sensing means, such as a float, associated with a rope, mesh or the like, may respond to sideways pressure on sides 16, 18, translated to tightening or loosening of the rope or mesh, as a result of increased water within pit 10. The sensing means could, having detected this situation, then adjust pump rates or the like to restore the pit 10 to a more desired status.

The upper apertures 38 may be associated with a vertical (in use) pipe (not shown) on the upstream side, which bends through 90° and passes through the associated wall. The upper level of this pipe may be used to establish the water level, and thus the water in each of chamber 1 to 8. This may act like a weir.

The pit 10 is adapted to be fully floating by itself and may be secured in place in the body of water, such as a dam, reservoir, lake or river, by ropes or using other methods. Alternative arrangements may include locating the pit 10 in a dam, where it takes water from the dam and the resulting treated water is pumped elsewhere. Or the pit 10 may be located in a dam, and the contaminated water is pumped from elsewhere into pit 10 and the treated water is released into the dam. Another alternative is to locate a pit 10 in a dam, and to pump contaminated water from elsewhere into pit 10, and the treated water pumped to another location.

Two or more pits 10 may be connected together in series to provide multiple processing, or may be placed parallel to one another to double the volume treatable or to double the treatment rate. If different designs of pits 10 are connected together in series they are able to provide different types of water processing. For example, first stage pH adjustment, second stage flocculation requiring different mixing aggressiveness, third stage, metal removal, and possibly a final stage for activated carbon polishing. A large pit 10 of this design without chambers could also be used for storage of treated water.

It may be a preferment or alternative for a pit 10 to be constructed in a modular arrangement. For example, groups of chambers, such as, say, chambers 1 and 2, chambers 3, 4, 5 and 6, chamber 7 and so on, could be manufactured as separate units. This may make manufacture, storage, installation and repair easier, as well as allowing different use sections to be matched to different treatment requirements, and providing general flexibility. For example, one type of treatment may require two units of chamber 3, 4, 5 and 6.

The units may be bolted together along each vertical wall (such as walls 24 and 26). This may be effected using plastic bolts (not shown) though punched eyelets (also not shown). This modular arrangement would result in a double wall where one unit is secured to an adjacent unit, adding to the material used, compared to a pit 10 constructed in one piece, but the benefits would, it is believed, greatly outweigh the costs. The apertures 36, 38 would have to be aligned when the end wall of one unit is secured to the end wall of a second unit, to allow free flow of water from the chamber one side of the joined units to the chamber of the other side of the connecting walls.

This method utilizes a water body to contain the treatment pits 10 thereby minimizing time for installation and room required. The pits 10 may be self-supporting, in that their design holds them to shape when full, or, can be built around and internal or external frame or brace, or may be held in place and shape by connecting to the bottom, bank or other structure. Pits 10 design may also be constructed in-ground without the float supporting structure.

This design of pits 10 described herein may be used in any manner in which water requires holding, holding for treatment or continual processing. This includes chemical treatment, chemical precipitation, electro coagulation, sterilization, filtering, ion exchange, and so on. These systems can be set up to provide single, dual or multiple process water treatment where the water transfers from one pit 10 to the next to have the same or a totally different process applied to it, or the water may be batch treated in the pit or pits 10.

There are many different applications for the system described herein. It may be installed into a dam or lake or a depression in the ground to contain contaminated water within the larger water body, or it could contain treated water storage in the larger body of water. It could be located in the watercourse (river bed) of a flowing river or stream to treat water from that river or stream, or may treat water from another source for discharge into the river or stream, or to another location. It could contain fresh water in a salty or other environment.

There are many different contaminated water situations that the pit 10 system of this invention could be used for. Drinking water treatment, water treatment for industry, acid mine drainage treatment, treatment in which chemicals are added prior to use elsewhere, are examples. It could also be used to store a fluid in another fluid environment. The system of this invention may be placed in a body of water such as a dam, which contains clean water. Contaminated water could be brought into the pit 10 from another source and treated water discharged into the body of water or to another location.

Any combination of location, source of contaminated water and discharge location may be used. For example, contaminated water may be pumped from a mineshaft into a pit 10 floating in a body of water, treated, and then discharged into the body of water, or to another location. By way of a preference, the pumps used to move water into and out of the pit 10 and within pit 10 may be centrifugal pumps or axial flow pumps beatable on or in one or more of chambers 1 through 8.

The entire contents of the specification and drawings of Australian provisional patent application no. 2010902882 filed on 30 Jun. 2011 are herewith incorporated into this specification.

1. Apparatus for use in the treatment of a substance, in particular a liquid, and more particularly contaminated water, said apparatus including a structure for location in a depression or the like, preferably adjacent a body which consists of or contains said substance, or being adapted to be located in a watercourse or the like, or being adapted to float on and/or in said body, said structure comprising at least one chamber in which said substance is treated before being returned to said body or being transferred to another location.

2. Apparatus according to claim 1, wherein said structure comprises a plurality of said chambers.

3. Apparatus according to claim 2, characterised in that said chambers are separated by walls, said walls being provided with one or more apertures, through which or each said aperture said substance may pass from one chamber to an adjacent chamber.

4. Apparatus according to claim 3, characterised in that said apertures are located in different parts of successive walls.

5. Apparatus according to claim 3, characterised in that said apertures are located towards the top of a first wall, and towards the base of the next wall, or vice versa.

6. Apparatus according to claim 5, characterised in that when said apparatus is intended to float in a body of liquid, said structure is provided with float means.

7. Apparatus according to claim 6, comprising means associated with said float means to adjust the height, of said apparatus relative to the surface of said body of liquid.

8. Apparatus according to claim 4, characterized in that when said apparatus is intended to float in a body of liquid, said structure is provided with float means.

9. Apparatus according to claim 8, comprising means associated with said float means to adjust the height of said apparatus relative to the surface of said body of liquid.

10. Apparatus according to claim 3, characterized in that when said apparatus is intended to float in a body of liquid, said structure is provided with float means.

11. Apparatus according to claim 10, comprising means associated with said float means to adjust the height of said apparatus relative to the surface of said body of liquid.

12. Apparatus according to claim 2, characterized in that when said apparatus is intended to float in a body of liquid, said structure is provided with float means.

13. Apparatus according to claim 12, comprising means associated with said float means to adjust the height of said apparatus relative to the surface of said body of liquid.

14. Apparatus according to claim 2, characterized in that said apertures are located towards the top of a first wall, and towards the base of the next wall, or vice versa.

15. Apparatus according to claim 1, characterized in that when said apparatus is intended to float in a body of liquid, said structure is provided with float means.

16. Apparatus according to claim 15, comprising means associated with said float means to adjust the height of said apparatus relative to the surface of said body of liquid.

17. An apparatus according to claim 1, characterized in that said apparatus is adapted to be constructed in a modular form, such that one modular part may contain one or more of said chambers, said one modular part being adapted to be connected to a second modular part which may contain one or more of said chambers.

18. Apparatus according to claim 2, characterized in that said apparatus is adapted to be constructed in a modular form, such that one modular part may contain one or more of said chambers, said one modular part being adapted to be connected to a second modular part which may contain one or more of said chambers.

19. Apparatus according to claim 3, characterized in that said apparatus is adapted to be constructed in a modular form, such that one modular part may contain one or more of said chambers, said one modular pan being adapted to be connected to a second modular part which may contain one or more of said chambers.

20. Apparatus according to claim 4, characterized in that said apparatus is adapted to be constructed in a modular form, such that one modular part may contain one or more of said chambers, said one modular part being adapted to be connected to a second modular part which may contain one or more of said chambers.
